(19) United States
(12) Patent Application Publication
(10) Pub. No.: US 2026/0267698 A1
(43) Pub. Date: Sep. 10, 2026

(54) SUPPORTING MULTIPLE APPLICATIONS IN DATA PROCESSING ENGINE COLUMNS

(71) Applicant: XILINX, INC., San Jose, CA (US)

(72) Inventors: Juan J. NOGUERA SERRA, San Jose, CA (US); David Patrick CLARKE, Dublin (IE); Javier CABEZAS RODRIGUEZ, Austin, TX (US); Mikhail ASIATICI, Cambridge (GB); Patrick SCHLANGEN, Köln (DE); Sneha Bhalchandra DATE, San Jose, CA (US)

(21) Appl. No.: 19/073,817

(22) Filed: Mar. 7, 2025

(51) Int. Cl. G06F 9/50; G06F 9/54; G06F 15/80

(52) U.S. Cl. CPC G06F 9/5027; G06F 9/54; G06F 15/80; G06F 2209/5012; G06F 2209/543

(57) ABSTRACT

A hardware accelerator is described that includes an array of data processing engines (DPEs) which can execute multiple applications (or multiple different workloads) in the same column. For example, a column may include four DPEs where two of the DPEs execute a first application and the other two DPEs execute a second application, or one of the DPEs executes the first application and the other three DPEs execute the second application. This gives a programmer additionally flexibility to determine how to assign applications to the hardware accelerator.

### TECHNICAL FIELD

Examples of the present disclosure generally relate to executing workloads using parallel hardware, for example, executing multiple applications in artificial intelligence engine (AIE) columns.

### BACKGROUND

One example of a parallel hardware architecture is an array of processing engines which can improve execution efficiency relative to serial hardware architectures because the parallel architectures are capable of executing workload components simultaneously. However, a user may wish to execute multiple different workloads (e.g., applications) in the same array. If an application is assigned the entire array, the workload may not be sufficient to keep the array busy, thereby resulting in idle or inefficiently used compute resources.

### SUMMARY

One embodiment herein is a hardware accelerator array that includes a plurality of data processing engine (DPE) tiles arranged in a plurality of columns and a plurality of interface tiles in the columns where DPE tiles in a same column are configured to execute different applications in parallel, and where hardware resources in a first interface tile in the same column are divided between the DPE tiles.

Another embodiment herein a hardware accelerator array that includes a plurality of data processing engine (DPE) tiles arranged in a plurality of columns and a plurality of interface tiles in the columns, a first DPE tile in a same column as a second DPE tile are configured to execute different applications in parallel, and where the first DPE tile comprises vertical connection reserved for use by the second DPE tile to communicate with a first interface tile in the same column.

Another embodiment herein is a method for configuring a plurality of data processing engines (DPEs) arranged in a plurality of columns in a hardware accelerator array. The method includes receiving a binary configured to execute on a subset of DPE tiles in one of the plurality of columns, selecting a column of the plurality of columns to execute the binary, and configuring a subset of the DPE tiles in the selected column to execute the binary while at least one other DPE tile in the selected column executes a different binary.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 is a block diagram of a hardware accelerator array, according to an example.

FIG. 2 is a block diagram of a data processing engine, according to an example.

FIG. 3 is a block diagram of an array executing multiple applications in the same column, according to an example.

FIG. 4 is a block diagram of executing multiple applications in the same column, according to an example.

FIG. 5 illustrates hardware for protecting and isolating user data in the tiles of a hardware accelerator array, according to an example.

FIG. 6 is a flowchart for configuring an array to execute an application using a sub-portion of a column, according to an example.

FIG. 7 illustrates different possible configurations for executing an application in an array, according to an example.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Embodiments herein describe a hardware accelerator with an array of data processing engines (DPEs) which can execute multiple applications (or multiple different workloads) in the same column. For example, a column may include four DPEs where two of the DPEs execute a first application and the other two DPEs execute a second application, or one of the DPEs executes the first application and the other three DPEs execute the second application. This gives the runtime firmware additionally flexibility to determine how to assign applications to the hardware accelerator. For example, lightweight or low priority applications may be assigned to execute using sub-portions of a column while higher priority application are assigned an entire column (or multiple columns) of the array.

In one embodiment, the array includes memory tiles or interface tiles (also referred to as shim tiles). For example, the array may include one or more rows of memory tiles used to store data for the DPEs, and a row of interface tiles for transferring data into, and out of, the array. As such, the DPEs in the same column may share the same memory and interface tiles. When DPEs in the same columns are assigned to different applications, the resources in the memory tiles and interface tiles can be divided up. This means both applications can use these tiles, as well as protecting and isolating the data in the case where the applications may correspond to two different users (e.g., applications for two different virtual machines (VMs)). In this manner, the DPEs in the same column can be allocated to different applications while the ancillary tiles in the column (e.g., memory and interface tiles) have their resources divided up and shared by the applications.

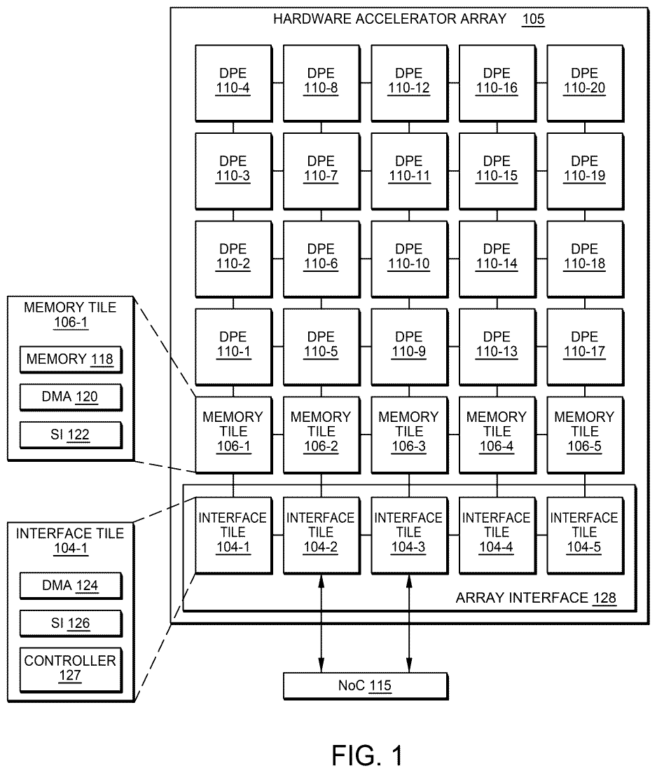

FIG. 1 is a block diagram of a hardware accelerator array 105, according to an example. In this example, the hardware accelerator array 105 includes a plurality of circuit blocks, or tiles, illustrated here as the DPEs 110 (also referred to as DPE tiles or compute tiles), interface tiles 104, and memory tiles 106. Memory tiles 106 may be referred to as shared memory and/or shared memory tiles. Interface tiles 104 may be referred to as shim tiles, and may be collectively referred to as an array interface 128. The hardware accelerator array 105 is coupled to a NoC 115, which couples the array 105 to other components in the same IC (or same SoC) such as a CPU, graphics processing unit (GPU), memory controller, and the like. FIG. 1 further illustrates that the interface tiles 104 communicatively couple the other tiles in the hardware accelerator array 105 (i.e., the DPEs 110 and memory tiles 106) to the NoC 115.

DPEs 110 can include one or more processing cores, program memory (PM), data memory (DM), DMA circuitry, and stream interconnect (SI) circuitry. For example, the core(s) is the DPEs 110 can execute program code stored in the PM. The core(s) may include, without limitation, a scalar processor and/or a vector processor. DM may be referred to herein as local memory or local data memory, in contrast to the memory tiles 106 which have memory that is external to the DPE tiles, but still within the hardware accelerator array 105.

The core(s) in the DPEs 110 may directly access data memory of other DPE tiles via DMA circuitry. The core(s) may also access DM of adjacent (or neighboring) DPEs 110 via DMA circuitry and/or DMA circuitry of the adjacent compute tiles. In one embodiment, DM in one DPE 110 and DM of adjacent DPE tiles may be presented to the core(s) as a unified region of memory. In one embodiment, the core(s) in one DPE 110 may access data memory of non-adjacent DPEs 110. Permitting cores to access data memory of other DPE tiles may be useful to share data amongst the DPEs 110.

The hardware accelerator array 105 may include direct core-to-core cascade connections amongst DPEs 110. Direct core-to-core cascade connections may include unidirectional and/or bidirectional direct connections. Core-to-core cascade connections may be useful to share data amongst cores of the DPEs 110 with relatively low latency (e.g., the data does not traverse stream interconnect circuitry, and the data does not need to be written to data memory of an originating DPE and read by a recipient or destination DPE). For example, a direct core-to-core cascade connection may be useful to provide results from an accumulation register of a processing core of an originating DPE directly to a processing core(s) of a destination DPE.

In an embodiment, DPEs 110 do not include cache memory. Omitting cache memory may be useful to provide predictable/deterministic performance. Omitting cache memory may also be useful to reduce processing overhead associated with maintaining coherency among cache memories across the DPEs 110.

In an embodiment, processing cores of the DPE 110 do not utilize input interrupts. Omitting interrupts may be useful to permit the processing cores to operate uninterrupted. Omitting interrupts may also be useful to provide predictable and/or deterministic performance.

One or more DPEs 110 may include special purpose or specialized circuitry, or may be configured as special purpose or specialized compute tiles such as, without limitation, digital signal processing engines, cryptographic engines, forward error correction (FEC) engines, and/or artificial intelligence (AI) engines.

In an embodiment, the DPEs 110, or a subset thereof, are substantially identically to one another (i.e., homogenous compute tiles). Alternatively, one or more DPEs 110 may differ from one other more other DPEs 110 (i.e., heterogeneous compute tiles).

Memory tile 106-1 includes memory 118 (e.g., random access memory or RAM), DMA circuitry 120, and stream interconnect (SI) circuitry 122.

Memory tile 106-1 may lack or omit computational components such as an instruction processor or a core. In an embodiment, memory tiles 106, or a subset thereof, are substantially identical to one another (i.e., homogenous memory tiles). Alternatively, one or more memory tiles 106 may differ from one other more other memory tiles 106 (i.e., heterogeneous memory tiles). A memory tile 106 may be accessible to multiple DPEs 110. Memory tiles 106 may thus be referred to as shared memory.

Data may be moved between/amongst memory tiles 106 via DMA circuitry 120 and/or stream interconnect circuitry 122 of the respective memory tiles 106. Data may also be moved between/amongst data memory of a DPE 110 and memory 118 of a memory tile 106 via DMA circuitry and/or stream interconnect circuitry of the respective tiles. For example, DMA circuitry in a DPE 110 may read data from its data memory and forward the data to memory tile 106-1 in a write command, via stream interconnect circuitry in the DPE 110 and stream interconnect circuitry 122 in the memory tile 106. DMA circuitry 124 of memory tile 106-1 may then write the data to memory 118. As another example, DMA circuitry 120 of memory tile 106-1 may read data from memory 118 and forward the data to a DPE 110 in a write command, via stream interconnect circuitry 122 and stream interconnect circuitry in the DPE 110, and DMA circuitry in the DPE 110 can write the data to its data memory.

Array interface 128 interfaces between the hardware accelerator array 105 (e.g., DPEs 110 and memory tiles 106) and the NoC 115. Interface tile 104-1 (also referred to as a shim tile) includes DMA circuitry 124, stream interconnect circuitry 126, and a controller 127. Interface tiles 104 may be interconnected so that data may be propagated amongst interface tiles 104 bi-directionally. An interface tile 104 may operate as an interface for column of DPEs 110 (e.g., as an interface to the NoC 115). Interface tiles 104 may be connected such that data may propagate from one interface tile 104 to another interface tile 104 bi-directionally.

In an embodiment, interface tiles 104, or a subset thereof, are substantially identically to one another (i.e., homogenous interface tiles). Alternatively, one or more interface tiles 104 may differ from one other more other interface tiles 104 (i.e., heterogeneous interface tiles).

In an embodiment, one or more interface tiles 104 are configured as a NoC interface tile (e.g., as primary and/or secondary device) that interfaces between the DPEs 110 and the NoC 115 (e.g., to access other components in the SoC). While FIG. 1 illustrates coupling a subset of the interface tiles 104 to the NoC 115, in one embodiment, each of the interface tiles 104-1-5 is connected to the NoC 115. Doing so may permit different applications to control and use different columns of the memory tiles 106 and DPEs 110.

The controllers 127 in each of the interface tiles 104 can program or configure the DMA circuitry and stream interconnect circuitry of the hardware accelerator array 105 to provide desired functionality and/or connections to move data between/amongst DPEs 110, memory tiles 106, and the NoC 115. This enables the DPEs 110 to perform a desired operation (e.g., a ML function). The DMA circuitry and stream interconnect circuitry of the hardware accelerator array 105 may include, without limitation, switches and/or multiplexers that are configurable to establish signal paths within, amongst, and/or between tiles of the hardware accelerator array 105. The hardware accelerator array 105 may further include configurable Advanced eXtensible Interface (AXI) AXI interface circuitry. The DMA circuitry, the stream interconnect circuitry, and/or AXI interface circuitry may be configured or programmed by storing configuration parameters in configuration registers, configuration memory (e.g., configuration random access memory or CRAM), and/or eFuses, and coupling read outputs of the configuration registers, CRAM, and/or eFuses to functional circuitry (e.g., to a control input of a multiplexer or switch), to maintain the functional circuitry in a desired configuration or state. In an embodiment, the core(s) of DPEs 110 configure the DMA circuitry and stream interconnect circuitry of the respective DPEs 110 based on core code stored in PM of the respective DPEs 110. The controllers 127 in each column can configure DMA circuitry and stream interconnect circuitry of memory tiles 106 and interface tiles 104 in that particular column based on controller code. Moreover, in one embodiment, the controllers 127 in each column can configure DMA circuitry for the DPEs 110 in their respective columns.

While FIG. 1 illustrates a controller 127 per column, there may be other arrangements where multiple controllers are tasked with controlling different subsets of tiles in the hardware accelerator. For example, the array may include a controller in every other column, where each controller is tasked with controlling tiles in two columns. In another example, there may be multiple controllers per column where each controller is tasked with controlling a different subset of tiles within the column.

In one embodiment, the controllers 127 are microprocessors. The controllers 127 can be hardened circuitry that executes software code (or firmware) that controls the DPE. In one embodiment, the only task of the controllers 127 is to control and orchestrate the functions performed by the array 105. However, in other embodiments, other tasks may be performed by the controllers 127, such as moving data into and out of the array 105 using the NoC 115. For example, the controllers 127 may communicate with a memory controller (not shown) to store data in, or retrieve data from, the memory (either in the same IC as the array 105 or on a different IC). In this example, the controllers 127 may execute different specialized code depending on the task a CPU has currently assigned to the array 105.

The hardware accelerator array 105 may include a hierarchical memory structure. For example, data memory of the DPEs 110 may represent a first level (L1) of memory, memory 118 of memory tiles 106 may represent a second level (L2) of memory, and external memory outside the hardware accelerator array 105 may represent a third level (L3) of memory. Memory capacity may progressively decrease with each level (e.g., memory 118 of memory tile 106 may have more storage capacity than data memory in the DPEs 110, and external memory may have more storage capacity than data memory 118 of the memory tiles 106). The hierarchical memory structure is not, however, limited to the foregoing examples.

As an example, in an artificial intelligence (AI) application, an input tensor may be relatively large (e.g., 1 megabyte or MB). Local data memory in the DPEs 110 may be significantly smaller (e.g., 64 kilobytes or KB). The controller 127 may segment an input tensor and store the segments in respective blocks of shared memory tiles 106.

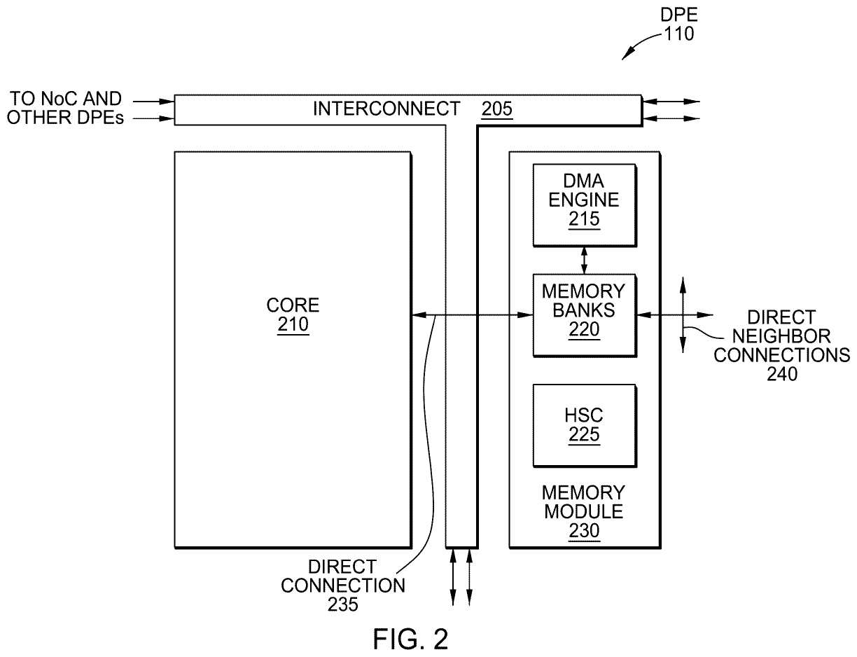

FIG. 2 is a block diagram of a DPE, according to an example. In this example, FIG. 2 illustrates one implementation of the DPE 110 in the hardware accelerator array 105 illustrated in FIG. 1, according to an example. The DPE 110 includes an interconnect 205, a core 210, and a memory module 230. The interconnect 205 permits data to be transferred from the core 210 and the memory module 230 to different cores in the array. That is, the interconnect 205 in each of the DPEs 110 may be connected to each other so that data can be transferred north and south (e.g., up and down) as well as east and west (e.g., right and left) between the DPEs 110 in the array.

For example, the DPEs 110 in an upper row of the array rely on the interconnects 205 in the DPEs 110 in a lower row to communicate with the NoC 115 shown in FIG. 2. For example, to transmit data to the NoC, a core 210 in a DPE 110 in the upper row transmits data to its interconnect 205 which is in turn communicatively coupled to the interconnect 205 in the DPE 110 in the lower row. The interconnect 205 in the lower row is connected to the NoC. The process may be reversed where data intended for a DPE 110 in the upper row is first transmitted from the NoC to the interconnect 205 in the lower row and then to the interconnect 205 in the upper row that is the target DPE 110. In this manner, DPEs 110 in the upper rows may rely on the interconnects 205 in the DPEs 110 in the lower rows to transmit data to and receive data from the NoC.

In one embodiment, the interconnect 205 includes a configurable switching network that permits the user to determine how data is routed through the interconnect 205. In one embodiment, unlike in a packet routing network, the interconnect 205 may form streaming point-to-point connections. That is, the streaming connections and streaming interconnects (not shown in FIG. 2) in the interconnect 205 may form routes from the core 210 and the memory module 230 to the neighboring DPEs 110 or the NoC. Once configured, the core 210 and the memory module 230 can transmit and receive streaming data along those routes. In one embodiment, the interconnect 205 is configured using the AXI Streaming protocol. However, when communicating with the NoC, the DPEs 110 may use the AXI memory mapped (MM) protocol.

In addition to forming a streaming network, the interconnect 205 may include a separate network for programming or configuring the hardware elements in the DPE 110. Although not shown, the interconnect 205 may include a memory mapped interconnect (e.g., AXI MM) which includes different connections and switch elements used to set values of configuration registers in the DPE 110 that alter or set functions of the streaming network, the core 210, and the memory module 230.

In one embodiment, streaming interconnects (or network) in the interconnect 205 support two different modes of operation referred to herein as circuit switching and packet switching. In one embodiment, both of these modes are part of, or compatible with, the same streaming protocol-e.g., an AXI Streaming protocol. Circuit switching relies on reserved point-to-point communication paths between a source DPE 110 to one or more destination DPEs 110. In one embodiment, the point-to-point communication path used when performing circuit switching in the interconnect 205 is not shared with other streams (regardless of whether those streams are circuit switched or packet switched). However, when transmitting streaming data between two or more DPEs 110 using packet-switching, the same physical wires can be shared with other logical streams.

The core 210 may include hardware elements for processing digital signals. For example, the core 210 may be used to process signals related to wireless communication, radar, vector operations, machine learning (ML)/AI applications, and the like. As such, the core 210 may include program memories, an instruction fetch/decode unit, fixed-point vector units, floating-point vector units, arithmetic logic units (ALUs), multiply accumulators (MAC), and the like. However, as mentioned above, this disclosure is not limited to DPEs 110. The hardware elements in the core 210 may change depending on the engine type. That is, the cores in an AI engine, digital signal processing engine, cryptographic engine, or FEC may be different.

The memory module 230 includes a DMA engine 215, memory banks 220, and hardware synchronization circuitry (HSC) 225 or other type of hardware synchronization block. In one embodiment, the DMA engine 215 enables data to be received by, and transmitted to, the interconnect 205. That is, the DMA engine 215 may be used to perform DMA reads and write to the memory banks 220 using data received via the interconnect 205 from the NoC or other DPEs 110 in the array.

The memory banks 220 can include any number of physical memory elements (e.g., SRAM). For example, the memory module 230 may be include 4, 8, 16, 32, etc. different memory banks 220. In this embodiment, the core 210 has a direct connection 235 to the memory banks 220. Stated differently, the core 210 can write data to, or read data from, the memory banks 220 without using the interconnect 205. That is, the direct connection 235 may be separate from the interconnect 205. In one embodiment, one or more wires in the direct connection 235 communicatively couple the core 210 to a memory interface in the memory module 230 which is in turn coupled to the memory banks 220.

In one embodiment, the memory module 230 also has direct connections 240 to cores in neighboring DPEs 110. Put differently, a neighboring DPE in the array can read data from, or write data into, the memory banks 220 using the direct neighbor connections 240 without relying on their interconnects or the interconnect 205 shown in FIG. 2. The HSC 225 can be used to govern or protect access to the memory banks 220. In one embodiment, before the core 210 or a core in a neighboring DPE can read data from, or write data into, the memory banks 220, the core (or the DMA engine 215) requests a lock acquire to the HSC 225 when it wants to read or write to the memory banks 220 (i.e., when the core/DMA engine want to “own” a buffer, which is an assigned portion of the memory banks 220. If the core or DMA engine does not acquire the lock, the HSC 225 will stall (e.g., stop) the core or DMA engine from accessing the memory banks 220. When the core or DMA engine is done with the buffer, they release the lock to the HSC 225. In one embodiment, the HSC 225 synchronizes the DMA engine 215 and core 210 in the same DPE 110 (i.e., memory banks 220 in one DPE 110 are shared between the DMA engine 215 and the core 210). Once the write is complete, the core (or the DMA engine 215) can release the lock which permits cores in neighboring DPEs to read the data.

Because the core 210 and the cores in neighboring DPEs 110 can directly access the memory module 230, the memory banks 220 can be considered as shared memory between the DPEs 110. That is, the neighboring DPEs can directly access the memory banks 220 in a similar way as the core 210 that is in the same DPE 110 as the memory banks 220. Thus, if the core 210 wants to transmit data to a core in a neighboring DPE, the core 210 can write the data into the memory bank 220. The neighboring DPE can then retrieve the data from the memory bank 220 and begin processing the data. In this manner, the cores in neighboring DPEs 110 can transfer data using the HSC 225 while avoiding the extra latency introduced when using the interconnects 205. In contrast, if the core 210 wants to transfer data to a non-neighboring DPE in the array (i.e., a DPE without a direct connection 240 to the memory module 230), the core 210 uses the interconnects 205 to route the data to the memory module of the target DPE which may take longer to complete because of the added latency of using the interconnect 205 and because the data is copied into the memory module of the target DPE rather than being read from a shared memory module.

In addition to sharing the memory modules 230, the core 210 can have a direct connection to cores 210 in neighboring DPEs 110 using a core-to-core communication link (not shown). That is, instead of using either a shared memory module 230 or the interconnect 205, the core 210 can transmit data to another core in the array directly without storing the data in a memory module 230 or using the interconnect 205 (which can have buffers or other queues). For example, communicating using the core-to-core communication links may use less latency (or have high bandwidth) than transmitting data using the interconnect 205 or shared memory (which requires a core to write the data and then another core to read the data) which can offer more cost effective communication. In one embodiment, the core-to-core communication links can transmit data between two cores 210 in one clock cycle. In one embodiment, the data is transmitted between the cores on the link without being stored in any memory elements external to the cores 210. In one embodiment, the core 210 can transmit a data word or vector to a neighboring core using the links every clock cycle, but this is not a requirement.

In one embodiment, the communication links are streaming data links which permit the core 210 to stream data to a neighboring core. Further, the core 210 can include any number of communication links which can extend to different cores in the array. In this example, the DPE 110 has respective core-to-core communication links to cores located in DPEs in the array that are to the right and left (east and west) and up and down (north or south) of the core 210. However, in other embodiments, the core 210 in the DPE 110 illustrated in FIG. 2 may also have core-to-core communication links to cores disposed at a diagonal from the core 210. Further, if the core 210 is disposed at a bottom periphery or edge of the array, the core may have core-to-core communication links to only the cores to the left, right, and bottom of the core 210.

However, using shared memory in the memory module 230 or the core-to-core communication links may be available if the destination of the data generated by the core 210 is a neighboring core or DPE. For example, if the data is destined for a non-neighboring DPE (i.e., any DPE that DPE 110 does not have a direct neighboring connection 240 or a core-to-core communication link), the core 210 uses the interconnects 205 in the DPEs to route the data to the appropriate destination. As mentioned above, the interconnects 205 in the DPEs 110 may be configured when the SoC is being booted up to establish point-to-point streaming connections to non-neighboring DPEs to which the core 210 will transmit data during operation.

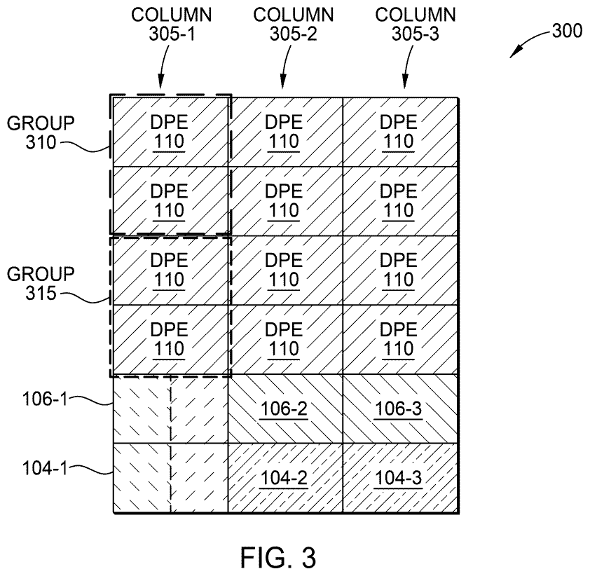

FIG. 3 is a block diagram of an array 300 executing multiple applications in the same column, according to an example. As shown, the array 300 includes three columns 305-1-3 that have four rows of DPEs 110, one row of memory tiles 106, and one row of interface tiles 104.

In this example, the top two DPEs 110 in column 305-1 are assigned to group 310 to execute a first application (or workload) while the bottom two DPEs 110 in column 305-1 are assigned to group 315 to execute a second application (or workload). The first and second applications can be for the same user/client (e.g., the same VM) or for a different user/client (e.g., different VMs). For example, the hardware accelerator containing the array 300 can be a shared resource in a data center or cloud computing environment. The array 300 may be used to execute applications for different users or customers of the data center. As discussed below, the DPEs 110, memory tiles 106, and interface tiles 104 can include security features (e.g., hardware) for isolating and protecting the data of two applications executing in the same column 305-1. In another embodiment, the hardware accelerator containing the array 300 can be in a personal computer (desktop, laptop, etc.) that is running several different AI applications. The computer can assign different groups of DPEs 110 to different ones of the AI applications.

The other two columns 305-2 and 305-3 can execute different applications. For example, a third application may execute using the four DPEs 110 in column 305-2 while a fourth application may execute using the four DPEs 110 in column 305-3. Instead, in another example, a third application may execute using the eight DPEs 110 in columns 305-2 and 305-3. As discussed above, because the DPEs 110 have lateral and vertical communication channels (e.g., using the interconnect 205 in FIG. 2, the direct neighbor connections 240, or the core-to-core communication links) multiple columns can be used to execute the same application. However, if neighboring columns execute different applications, the lateral communication channels between those columns may disabled when the array 300 is configured. This can improve data security and isolation.

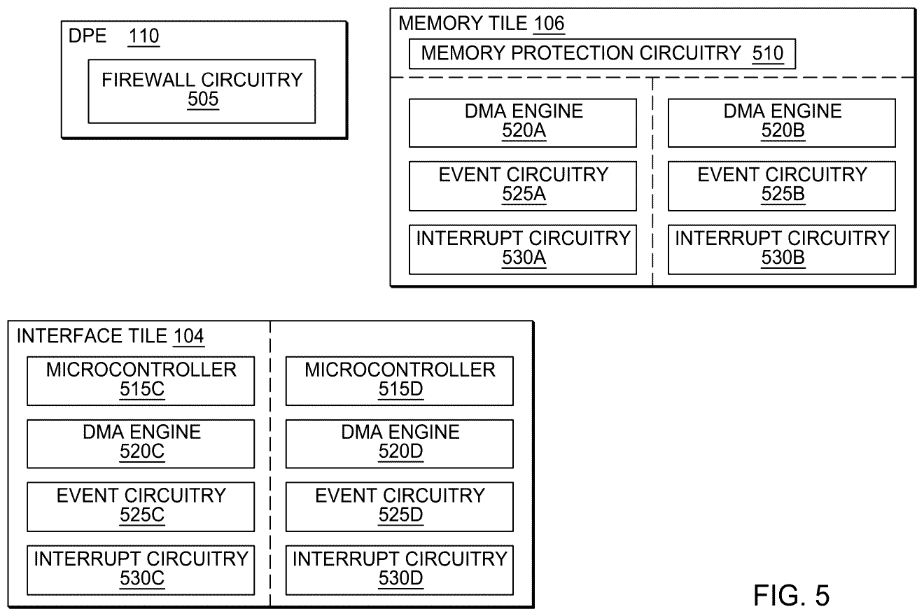

As discussed in FIG. 1, the DPEs 110 in the same column share the memory tile and interface tile in that column. However, if the DPEs 110 in group 310 and group 315 shared the entire memory tile 106-1 and interface tile 104-1, this means the DPEs in different groups (which correspond to different application) may be able to access each other's data. Instead, FIG. 3 illustrates dividing up the resources (e.g., circuitry) in the memory tile 106-1 and the interface tile 104-1 between the groups. For example, the DPEs 110 in group 315 may be able to access only the resources in the left half of the tiles 106-1 and 104-1 while the DPEs in group 310 can only access the resources in the right half of the tiles 106-1 and 104-1. While FIG. 3 illustrate dividing up these tiles in vertical haves, this is for ease of explanation and illustration purposes since the circuitry assigned to the different groups can be distributed throughout the tiles. The details of the hardware firewalls in the memory tile 106-1 and the interface tile 104-1 are discussed in FIG. 5.

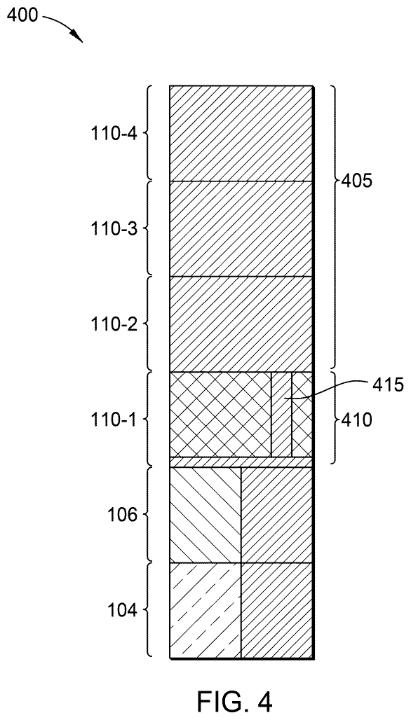

Moreover, some of the communications networks used by the DPEs 110 in the top group 310 may extend through the DPEs 110 in the bottom group 315. Stated differently, for the DPEs 110 in the top group 310 to communicate with the memory tile 106-1 and the interface tile 104-1, they may use the communication networks in the DPEs 110 in the bottom group 315 (e.g., some of the vertical connections in the interconnect 205 in FIG. 2). This is shown in FIG. 4.

FIG. 4 is a block diagram of executing multiple applications in the same column 400, according to an example. While one column 400 is shown, the hardware accelerator may have multiple columns (or could be a single column).

In this example, the top three DPEs 110-2-110-4 in column 400 are assigned to group 405 to execute a first application (or workload) while the bottom DPE 110-1 is assigned to group 410 to execute a second application (or workload). The first and second applications can be for the same user/client (e.g., the same VM) or for a different user/client (e.g., different VMs). For example, the hardware accelerator containing the column 400 can be a shared resource in a data center or cloud computing environment. The column 400 may be used to execute applications for different users or customers of the data center. As discussed below, the DPEs 110, memory tiles 106, and interface tiles 104 can include security features (e.g., hardware) for isolating and protecting the data of two applications executing in the same column 400.

The two shadings in FIG. 4 illustrate the different hardware assigned to the different applications. In this example, the three DPEs 110-2-110-4 are assigned half of the circuitry in the memory tile 106 and the shim tile 104, while the DPE 110-1 is assigned the other half of the circuitry in the memory tile 106 and the shim tile 104. That is, in this case, although one application is using three DPEs and the other application uses one DPE, the applications share the resources in the memory tile 106 and the shim tile 104 equally (e.g., 50/50).

However, in other embodiments, the resources in the memory tile 106 and the shim tile 104 may be shared proportionally to the number DPEs assigned to the groups. For example, because the group 405 has three of the four DPEs, it may be assigned 75% of the resources in the memory tile 106 and the shim tile 104 while the group 410 is assigned 25% of these tiles. This represents a tradeoff with performance and circuitry design/complexity. That is, in order for a memory tile 106 and shim tile 104 to be divided up, it may have multiple copies of certain types of circuitry such as controllers, direct memory access (DMA) engines, event circuitry, trace circuitry, and the like. Thus, for a memory tile 106 and shim tile 104 to be divided up into quarters, it may need four copies of this circuitry, rather than only two copies of this circuitry for the implementation illustrated in FIG. 4. Thus, it is a design choice at the time the hardware accelerator is designed to determine how many different divisions of the memory tiles 106 and shim tile 104 will be supported. For example, if a column has six or more DPEs, it may make sense to have the memory tile 106 and shim tile 104 support up to three groups of the DPEs (where each group can use a third of these tiles) but for implementations where the column has less than six DPEs, it may make sense to design the memory tile 106 and shim tile 104 to support only two different groups of DPEs.

Notably, if the memory tile 106 and shim tile 104 can support more than two groups but the column is currently executing only two groups (or only one group), the portions of the memory tile 106 and shim tile 104 can still be fully used. For example, if the column supports up to three groups but the DPEs are assigned to two groups, than ⅔ of the hardware in the memory tile 106 and the shim tile 104 can be assigned to one group of DPEs while the remaining ⅓ of the circuitry is assigned to the DPEs in the other group.

FIG. 4 also illustrates that a portion of the hardware in the DPE 110-1 (which is part of group 410) is assigned to group 405. In this example, vertical connections 415 in the DPE 110-1 are used by the DPEs 110-2-110-4 so these DPEs can communicate with the memory tile 106 and the interface tile 104. For example, the vertical connections 415 may be channels within the interconnect 205 of the DPE 110-1 as shown in FIG. 2. In one embodiment, without assigning the vertical connections 415 in the DPE 110-1 for use by the other DPEs 110-2-110-4, these DPEs would be unable to communicate with the memory tile 106 and the interface tile 104.

In one embodiment, the DPE 110-1 is unable to access/read or use the vertical connections 415. This enables data isolation/security between the groups 405 and 410. For example, there may be hardware circuitry in the DPEs 110 that can be used to lock out vertical connections 415 so they can be exclusively used by other DPEs in the column 400. In this manner, some vertical channels can be assigned to other DPEs while the remaining vertical channels can be used by the local DPE so it can communicate with the memory tile 106 and the interface tile 104.

FIG. 5 illustrates hardware for protecting and isolating user data in the tiles of a hardware accelerator array, according to an example. As shown, a DPE 110 in the array can include firewall circuitry 505. This circuitry can isolate circuitry (hardware resources) in the DPE 110 that is assigned to a DPE in a different group (e.g., a DPE executing a different application). For example, the firewall circuitry 505 can isolate the circuitry in the DPE 110 from connections in the DPE 110 that are assigned to other DPEs (such as the vertical connections 415 in FIG. 4). In addition to being used to isolate vertical connections, the firewall circuitry 505 can be used to isolate horizontal connections when the DPE 110 is assigned to execute a different application than DPEs in the same row.

The memory tile 106 includes memory protection circuitry 505 to divide up read/write channels in the memory tile 106. That is, the memory protection circuitry 505 can ensure that the memory resources in the tile 106 can be used exclusively by different groups of DPEs. For example, half of the read/write channels can be assigned to one group of DPEs in the same column while the other half are assigned to a second group of DPEs in the same column.

The memory tile 106 also includes DMA engines 520A and 520B, event circuitry 525A and 525B, and interrupt circuitry 530A and 530B. When the DPEs in the column are assigned to different groups or applications, the different copies of the circuitry in the memory tile 106 can be assigned to different groups as discussed above. The copies of the circuitry can be isolated from each other so that data privacy and security are maintained. In this manner, the memory tile 106 can provide the same services and functions to both groups of DPEs.

In contrast, when the DPEs in the column are in the same group or execute the same application, the copies of the circuitry can work together (e.g., there is no longer any data isolation). That is, the memory tile 106 can function similarly to a column that does not support dividing up the DPEs into different groups.

For the memory tile 106 to support dividing up the DPEs in the same column into more groups than two, the memory tile 106 can include additional copies of the DMA engine 520, event circuitry 525, and interrupt circuitry 530. Thus, the memory tile 106 can be designed to support additional groupings of the DPEs, but at the cost of adding new copies of the circuitry.

The interface tile 104 also includes copies of two copies of a microcontroller 515C and 515D, DMA engine 520C and 520D, event circuitry 525C and 525D, and interrupt circuitry 530C and 530D. When the DPEs in the column are assigned to different groups or applications, the different copies of the circuitry in the interface tile 104 can be assigned to different groups as discussed above. The copies of the circuitry can be isolated from each other so that data privacy and security are maintained. In this manner, the interface tile 104 can provide the same services and functions to both groups of DPEs.

The event circuitry 525 can be used to push notifications of events occurring in the memory tile 106 and the interface tile 104 (or events in different components in these tiles such as the microcontrollers 515) to other tiles. Although not shown, there may be an event network for broadcasting events occurring in the tiles to other tiles or to components outside the hardware accelerator.

In this example, the DMA engines 520 can be coupled to a stream switch. The DMA engines 520 can use the stream switch to communicate with other tiles in the hardware accelerator. The DMA engines 520 can use another switch (e.g., a multiplexer) to communicate with a NoC (e.g., the NoC 115 in FIG. 1) to fetch data from external memory to move data into, or out of, the interface tile 104.

In one embodiment, the microcontrollers 515 can be coupled to both an AXI-MM switch and a stream switch. The microcontrollers 515 can use these switches to communicate with neighboring interface tiles in the array. In one embodiment, the memory tiles 106 may not include microcontrollers. In that case, the memory tiles 106 can include interconnects to the DPE tiles, thereby permitting the microcontrollers 515 in the interface tile 104 to communicate with the DPE tiles via the memory tiles. Thus, in this example, the microcontrollers 515 can use both the MM and streaming protocols to communicate with other tiles in the hardware accelerator array.

The interrupt circuitry 530 can be used to signal to an external management processor or the host CPU. The source trigger for an interrupt may be due to (a) application completion, (b) software errors, (c) hardware errors, and the like.

When all the DPEs in a column work on the same application, a first microcontroller (e.g., the microcontroller 515D) can control each of the DPEs in the column while the other microcontroller (e.g., the microcontroller 515C) is idle. However, if control demand is very high (due to parameters of application) both microcontrollers can work together to control DPEs and the DMA engines 520 in both the interface and memory tiles. In that case, one of the microcontrollers can be the lead controller while the other microcontroller is a worker controller. For the event circuitry 530, when all the DPEs in a column work on the same application, one copy of the event circuitry is active while the other copy is disable.

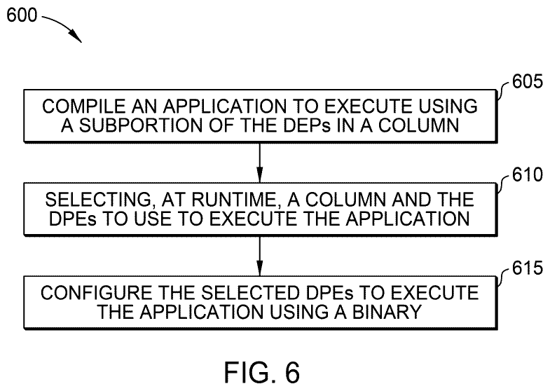

FIG. 6 is a flowchart of a method 600 for configuring an array to execute an application using a sub-portion of a column, according to an example. At block 605, a compiler compiles an application to execute using a subset of the DPEs in a column. At this stage, the compiler may not know the exact placement of the DPEs. Stated differently, the compiler may not know which DPEs in the array will be used to execute the application. For example, a programmer may know the number of DPEs she wishes to use to execute the application, but not which of the DPEs in the array should be used at runtime to execute the application.

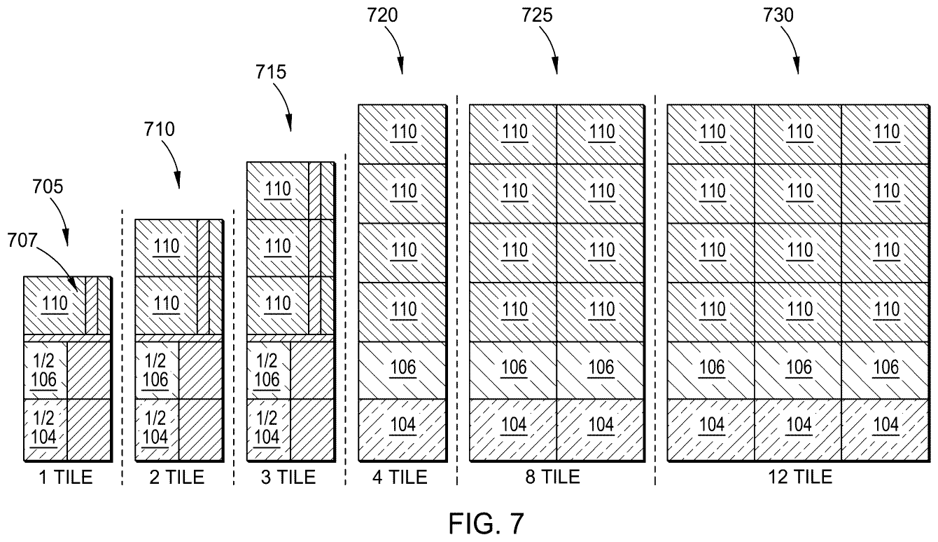

To compile the application, the compiler (and the programmer) may use a software view that is agnostic to which DPEs are used to execute the application during runtime. FIG. 7 illustrates different possible configurations for executing an application in an array, according to an example. That is, FIG. 7 illustrates different hardware configurations that a compiler can use to generate a binary for executing an application on an array of DPEs in a hardware accelerator. The programmer can select one of the configurations illustrated shown in FIG. 7 and then the compiler compiles the corresponding application code to generate a binary to execute on that configuration. As discussed later, a dynamic scheduler can then select the actual DPEs to use to implement the hardware configuration.

The configurations shown in FIG. 7 assume the hardware accelerator has an array that includes three columns that include four rows of DPEs 110, one row of memory tiles 106 and one row of interface tiles 104. The configuration 705 illustrates assigning one DPE 110 in a column to an application, along with half of the resources in the corresponding memory tile 106 and interface tile 104. That is, the binary generated by the compiler is executed on one DPE in a column. However, the binary is agnostic to which DPE in a column is used to execute the application. That is, with this binary, the dynamic scheduler is free to assign any of the DPEs in a column to the application (e.g., any of the four DPEs in the column). Moreover, the configuration 705 assumes that the DPE 110 may be used in a column where the other DPEs in that column execute a different application. Because the DPE 110 may not be the top DPE in that column, the configuration 705 includes reserving vertical connections 707 in the DPE 110 that can be used by other DPEs in the column to communicate with the memory tile 106 and the interface tile 104.

The configuration 710 illustrates assigning two DPEs 110 in a column to an application, along with half of the resources in the corresponding memory tile 106 and interface tile 104. That is, the binary generated by the compiler can be executed on two DPEs in a column. In one embodiment, the DPEs 110 are contiguous DPEs (i.e., directly neighboring or directly adjacent DPEs in the column). However, the binary is agnostic to which two DPEs in a column are used to execute the application. That is, with this binary, the dynamic scheduler is free to assign any two of the DPEs in a column to the application (e.g., the top two DPEs, the middle two DPEs, or the bottom two DPEs). Moreover, vertical connections can be reserved in the two DPEs so other DPEs in the same column can access the memory tile 106 and the interface tile 104.

The configuration 715 illustrates assigning three DPEs 110 in a column to an application, along with half of the resources in the corresponding memory tile 106 and interface tile 104. That is, the binary generated by the compiler can be executed on three DPEs in a column. In one embodiment, the three DPEs 110 are contiguous DPEs (i.e., directly neighboring DPEs in the column). However, the binary is agnostic to which three DPEs in a column are used to execute the application. That is, with this binary, the dynamic scheduler is free to assign any three of the DPEs in a column to the application (e.g., the top three DPEs or the bottom three DPEs). Moreover, vertical connections can be reserved in the three DPEs so the other DPE in the same column can access the memory tile 106 and the interface tile 104 (in the case the three DPEs are assigned to the bottom three DPEs in the column).

The configuration 720 illustrates assigning the four DPEs 110 in a column to an application, along with all of the resources in the corresponding memory tile 106 and interface tile 104. With this binary, the dynamic scheduler is free to assign any column in the array to the application.

The configuration 725 illustrates assigning two columns of DPEs 110 to an application, along with the resources in the corresponding memory tiles 106 and interface tiles 104. In this embodiment, the columns are directly adjacent columns. With this binary, the dynamic scheduler is free to assign any two columns in the array to the application (e.g., the left two columns or the right two columns in the array).

The configuration 730 illustrates assigning the three columns of the array to an application, along with the resources in the corresponding memory tiles 106 and interface tiles 104.

Returning to the method 600, at block 610 the dynamic scheduler selects, at runtime, a column (or columns) and DPEs to use to execute the application. For example, if the binary was compiled using the configuration 710 that relies on two DPEs in a column, the dynamic scheduler can select a column where two other DPEs in the column are already assigned to an application (which means the remaining two DPEs are available). This may be preferred relative to selecting a column where none of the DPEs are assigned.

The dynamic scheduler may place multiple different applications at a time onto the array. The dynamic scheduler can determine which placement results in the most DPEs being used. That is, the dynamic schedule can evaluate how to place the binaries so that the maximum number of DPEs are utilized.

At block 615, the dynamic scheduler configures the DPEs in the selected column to execute the application. This can include configuring DPEs that are not used to execute the application. For example, if the top two DPEs in a column are used to execute the application, the dynamic scheduler can configure the bottom two DPEs in that column to reserve vertical connections in those DPEs to be used by the top two DPEs as discussed above. Also, the dynamic scheduler can configure the memory tiles to perform data isolation when different DPEs in the same column execute different applications for different users.

In this manner, different DPEs in the same column can be configured to execute different applications or workloads in parallel.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

While the foregoing is directed to specific examples, other and further examples may be devised without departing from the basic scope thereof, and the scope thereof is determined by the claims that follow.

What is claimed is:

1. A hardware accelerator array comprising:
a plurality of data processing engine (DPE) tiles arranged in a plurality of columns; and
a plurality of interface tiles in the columns, wherein DPE tiles in a same column are configured to execute different applications in parallel, wherein hardware resources in a first interface tile in the same column are divided between the DPE tiles.

2. The hardware accelerator array of claim 1, wherein a first one of the DPE tiles executing a first application includes vertical connections that are reserved for use by a second one of the DPE tiles executing a second application so the second DPE tile can communicate with the first interface tile using the vertical connections.

3. The hardware accelerator array of claim 2, wherein the first DPE tile is disposed between the second DPE tile and the first interface tile in the same column, wherein the first DPE cannot read the data transmitted by the second DPE tile using the vertical connections.

4. The hardware accelerator array of claim 3, wherein the first DPE tile is one of at least two directly adjacent DPE tiles in the same column that are used to execute the first application, wherein the at least two DPE tiles include vertical connections so the second DPE tile can communicate with the first interface tile using the vertical connections.

5. The hardware accelerator array of claim 1, wherein the first interface tile comprises a plurality of DMA engines, wherein a first one of the plurality of DMA engines is assigned to a first one of the DPE tiles executing a first application and a second one of the plurality of DMA engines is assigned to a second one of the DPE tiles executing a second application.

6. The hardware accelerator array of claim 5, wherein the first interface tile comprises a plurality of controllers, at least two copies of event circuitry, and at least two copies of interrupt circuitry, wherein the first DPE tile is assigned a first one of the controllers, a first one of the two copies of the event circuitry, and a first one of the two copies of the interrupt circuitry, wherein the second DPE tile is assigned a second one of the controllers, a second one of the two copies of the event circuitry, and a second one of the two copies of the interrupt circuitry.

7. The hardware accelerator array of claim 1, further comprising:
a plurality of memory tiles arranged in the plurality of columns and configured to store data processed by the plurality of DPE tiles, wherein memory resources of a memory tile in the same column is divided between a first one of the DPE tiles executing a first application and a second one of the DPE tiles executing a second application.

8. The hardware accelerator array of claim 7, wherein the plurality of memory tiles are disposed between the plurality of interface tiles and the plurality of DPE tiles.

9. The hardware accelerator array of claim 1, wherein the plurality of interface tiles is coupled to a network on chip (NoC) to facilitate data communication into, and out of, the hardware accelerator array.

10. A hardware accelerator array comprising:
a plurality of data processing engine (DPE) tiles arranged in a plurality of columns; and
a plurality of interface tiles in the columns, wherein a first DPE tile in a same column as a second DPE tile are configured to execute different applications in parallel, wherein the first DPE tile comprises vertical connection reserved for use by the second DPE tile to communicate with a first interface tile in the same column.

11. The hardware accelerator array of claim 10, wherein vertical connections in the first DPE tile are reserved for use by the second DPE tile to communicate with the first interface tile.

12. The hardware accelerator array of claim 11, wherein the first DPE tile is disposed between the second DPE tile and the first interface tile in the same column, wherein the first DPE tile cannot read data transmitted by the second DPE tile using the vertical connections.

13. The hardware accelerator array of claim 12, wherein the first DPE tile is one of at least two directly adjacent DPE tiles in the same column that are used to execute a first application, wherein the at least two DPE tiles include vertical connections so the second DPE tile can communicate with the first interface tile using the vertical connections.

14. The hardware accelerator array of claim 11, wherein hardware resources in a first interface tile in the same column are divided between the first and second DPE tiles, wherein the first interface tile comprises a plurality of DMA engines, wherein a first one of the plurality of DMA engines is assigned to the first DPE tile and a second one of the plurality of DMA engines is assigned to the second DPE tile.

15. A method for configuring a plurality of data processing engines (DPEs) arranged in a plurality of columns in a hardware accelerator array, the method comprising:
receiving a binary configured to execute on a subset of DPE tiles in one of the plurality of columns;
selecting a column of the plurality of columns to execute the binary; and
configuring a subset of the DPE tiles in the selected column to execute the binary while at least one other DPE tile in the selected column executes a different binary.

16. The method of claim 15, wherein configuring the subset of the DPE tiles comprises reserving vertical connections in the subset of the DPE tiles to be used by the at least one other DPE tile to communicate with an interface tile in the selected column.

17. The method of claim 16, wherein the interface tile comprises multiple copies of DMA engines, event circuitry, controllers, and interrupt circuitry, wherein one copy of the DMA engines, event circuitry, controllers, and interrupt circuitry are assigned to the subset of the DPE tiles and one copy of the DMA engines, event circuitry, controllers, and interrupt circuitry are assigned to the at least one other DPE tile.

18. The method of claim 16, wherein the subset of the DPE tiles is disposed between the at least one other DPE tile and the interface tile in the selected column, wherein the subset of the DPE tiles cannot read data transmitted by the at least one other DPE tile using the vertical connections.

19. The method of claim 15, wherein the hardware accelerator array further comprises:
a plurality of memory tiles arranged in the plurality of columns and configured to store data processed by the DPE tiles, wherein the plurality of memory tiles comprises DMA circuitry, but do not have cores.

20. The method of claim 19, wherein memory resources in a first one of the plurality of memory tiles in the selected column are divided up between the subset of the DPE tiles and the at least one other DPE tile.
